(19) United States
(12) Patent Application Publication
(10) Pub. No.: US 2006/0212142 A1
(43) Pub. Date: Sep. 21, 2006

(54) System and method for providing interactive feature selection for training a document classification system

(76) Inventors: Omid Madani, San Gabriel, CA (US); Hema Raghavan, Amherst, MA (US); Rosie Jones, Pasadena, CA (US)

Correspondence Address: Brown Raysman Millstein Felder & Steiner, 900 Third Avenue, New York, NY, 10022, US

(21) Appl. No.: 11/376,989

(22) Filed: Mar. 15, 2006

Related U.S. Application Data
(60) Provisional application No. 60/662,306, filed on Mar. 16, 2005.

(51) Int. Cl. G05B 13/02

(52) U.S. Cl. 700/49

(57) ABSTRACT

A method for facilitating development of a document classification function comprises selecting a feature of a document, the feature being less than an entirety of the document; presenting the feature to a human subject; asking the human subject for a feature relevance value of the feature; and generating a classification function using the feature relevance value. The method may also include the steps of presenting the document to the human subject at the same time as presenting the feature; asking the human subject for document relevance value that measures relevance of the document to a category; and wherein the generating the classification function also uses the document relevance value.

### PRIORITY CLAIM

This application claims benefit of and hereby incorporates by reference provisional patent application Ser. No. 60/662,306, entitled “Interactive Feature Selection,” filed on Mar. 16, 2005, by inventors Omid Madani, et al.

### TECHNICAL FIELD

The present invention relates to the field of document classification, and in particular relates to a system and method for determining a document classification function for classifying documents.

### BACKGROUND

Computers are often called upon to classify documents, such as computer files, e.g., email, articles, etc. Document classification may be used to organize documents into a hierarchy of classes or categories. Using document classification techniques, finding documents related to a particular subject matter may be simplified.

Document classification may be used to route appropriate documents to appropriate people or locations. In this way, an information service can route documents covering diverse subject matters (e.g., business, sports, the stock market, football, a particular company, a particular football team) to people having diverse interests. Document classification may be used to filter objects so that a person is not annoyed by unwanted content (such as unwanted and unsolicited e-mail, also referred to as “spam” or to organize emails.

In some instances, documents must be classified with absolute certainty, based on certain accepted logic. A rule-based system may be used to effect such types of classification. Rule-based systems use production rules of the form of an “IF” condition, “THEN” response. Example conditions include determining whether documents include certain words or phrases, have a certain syntax, or have certain attributes. Example responses including routing the document to a particular folder or identifying the document as “spam.” For example, if the document has the word “close,” the word “nasdaq” and a number, then it may be classified as “stock market” text.

In many instances, rule-based systems become unwieldy, particularly in instances where the number of measured features is large, logic for combining conditions or rules is complex, and/or the number of possible classes is significant. Since text may have many features and complex semantics, these limitations of rule-based systems make them inappropriate for classifying text in all but the simplest applications.

Over the last decade or so, other types of classifiers have been used. Although these classifiers do not use static, predefined logic, as do rule-based classifiers, they have outperformed rule-based classifiers in many applications. Such classifiers typically include learning elements, such as neural networks, Bayesian networks, and support vector machines.

Some significant challenges exist when using systems having learning elements for text classification. For example, when training learning machines for text classification, a set of learning examples are used. Each learning example includes a vector of features associated with a text object. In many applications, the total number of features can be very large (for example, in the millions or beyond). A large number of features can easily be generated by considering the presence or absence of a word in a document to be a feature. If all of the words in a corpus are considered as possible features, then there can be millions of unique features. For example, web pages have many unique strings and can generate millions of features. An even larger number of features are possible if pairs or more general combinations of words or phrases are considered, or if the frequency of occurrence of words is considered.

When a learning machine is trained, it is trained based on training examples from a set of feature vectors. In general, performance of a learning machine will depend, to some extent, on the number of training examples used to train it. Even if there are a large number of training examples, there may be a relatively low number of training examples which belong to certain categories. The field of active learning is concerned with techniques that reduce training costs by intelligently picking training examples to label (obtain the category for) in a sequential manner. Active learning can ameliorate the need for substantial training data in order to learn a satisfactory performing categorizer. Active learning can be specifically useful in the above mentioned scenarios when the relevant features have to be determined from potentially large numbers of features, or when the category is relatively small compared to the universe of documents.

As human subjects review and label the various documents, the active learning algorithm must determine the distinguishing features from the various features available. Training a classification system can take substantial time. Given the above, it is desirable to devise a system and method to generate a document classification function more efficiently and effectively.

### SUMMARY

A major bottleneck in machine learning is the lack of sufficient labeled data for adequate document classification function determination, as manual labeling is often tedious and costly. However, there has been little work in supervised learning in which the teacher is queried on something other than whole instances. For example, to find documents on the topic of cars using traditional learning, the teacher may provide examples of car and non-car documents. Then, by classifying the documents as either relevant or not relevant, traditional learning estimates relevant features and generates the classification function. However, traditional learning ignores the prior knowledge that the user has, once a set of training examples have been obtained.

Experiments on human subjects (teachers) have shown that human feedback on feature relevance can identify a significant proportion (65%) of the most relevant features needed for document relevance classification. These experiments further showed that feature labeling takes about 80% less teacher time than document labeling. By identifying the most predictive features early on, the training system can incorporate feature feedback to improve and expedite document classification function development.

In one embodiment, the present invention provides a method for facilitating development of a document classification function, the method comprising selecting a feature of a document, the feature being less than an entirety of the document; presenting the feature to a human subject; asking the human subject for a feature relevance value of the feature; and generating a classification function using the feature relevance value.

The feature may include one of a word choice, a synonym, a date, an event, a person or link information. The feature relevance value may be a binary variable, a sliding scale value, or selected from a set of values. The method may also include the steps of presenting the document to the human subject at the same time as presenting the feature; asking the human subject for document relevance value that measure relevance of the document to a category; and wherein the generating the classification function also uses the document relevance value. The document relevance value is a binary value, a sliding scale value, or a value selected from a set of values. The step of generating the classification function may include assuming that the features deemed most relevant according to the feature relevance values are the most relevant features for evaluating relevance of a document to a category. The step of generating the classification function may include generating a feature weight based on the feature relevance value. The method may also include monitoring user actions, and modifying the feature weight based on the monitoring.

In another embodiment, the present invention provides a system for facilitating development of a classification function, the system comprising a feature selector for presenting a feature of a document to a human subject, the feature being less than an entirety of the document, and for asking the human subject for a feature relevance value of the feature; and a classification function determining module for generating a classification function using the feature relevance value.

The feature may include one of a word choice, a synonym, a date, an event, a person or link information. The feature relevance value may be a binary variable, a sliding scale value, or a value selected from a set of values. The system may also include a document selector for presenting a document to the human subject at the same time as presenting the feature, and for asking the human subject for a document relevance value that measures relevance of the document to a category; and wherein the classification function determining module also uses the document relevance value to generate the classification function. The document relevance value may be a binary value, a sliding scale value, or a value selected from a set of values. The classification function determining module may assume that the features deemed most relevant according to the feature relevance value are the most relevant features for evaluating relevance of a document to a category. The classification function determining module may generate a feature weight based on the feature relevance value. The system may also include a feedback module for monitoring user actions, and modifying the feature weight based on the monitoring.

In yet another embodiment, the present invention provides a system for facilitating development of a classification function, the system comprising means for presenting a feature of a document to a human subject, the feature being less than an entirety of the document; means for asking the human subject for a feature relevance value of the feature as a factor for determining relevance of a document to a category; and means for generating a classification function using the feature relevance value.

In another embodiment, the present invention provides a method for facilitating development of a document classification function, the method comprising enabling a human subject to identify a distinguishing feature of a document, the feature being less than an entirety of the document; and generating a classification function using the distinguishing feature.

In still another embodiment, the present invention provides a method for facilitating development of a document classification function, the method comprising selecting a plurality of features of a document, each of the features being less than an entirety of the document; presenting the features to a human subject; asking the human subject for feature relevance values of the features; and generating a classification function using the feature relevance values. The step of presenting may include presenting the features one at a time, presenting the features as a list, and/or presenting the features with document content information.

### BRIEF DESCRIPTION OF THE DRAWINGS

FIG. 1 is a block diagram illustrating a network system for training a document classification engine, in accordance with an embodiment of the present invention.

FIG. 2 is a block diagram illustrating a network system for training a document classification engine in a search engine environment, in accordance with an embodiment of the present invention.

FIG. 3 is a block diagram illustrating details of the classification system of FIG. 2, in accordance with an embodiment of the present invention.

FIG. 4 is an example feature feedback screen of a user interface.

FIG. 5 is a block diagram illustrating details of an example computer system, in accordance with an embodiment of the present invention.

FIG. 6 is a flowchart illustrating a method of training a document classification system, in accordance with an embodiment of the present invention.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

A major bottleneck in machine learning is the lack of sufficient labeled data for adequate document classification function determination, as manual labeling is often tedious and costly. However, there has been little work in supervised learning in which the teacher is queried on something other than whole instances. For example, to find documents on the topic of cars using traditional learning, the teacher may provide examples of car and non-car documents. Then, by classifying the documents as either relevant or not relevant, traditional learning estimates relevant features and generates the classification function. However, traditional learning ignores the prior knowledge that the user has, once a set of training examples have been obtained.

Experiments on human subjects (teachers) have shown that human feedback on feature relevance can identify a significant proportion (65%) of the most relevant features needed for document relevance classification. These experiments further showed that feature labeling takes about 80% less teacher time than document labeling. By identifying the most predictive features early on, a training system can incorporate feature feedback to improve and expedite document classification function development.

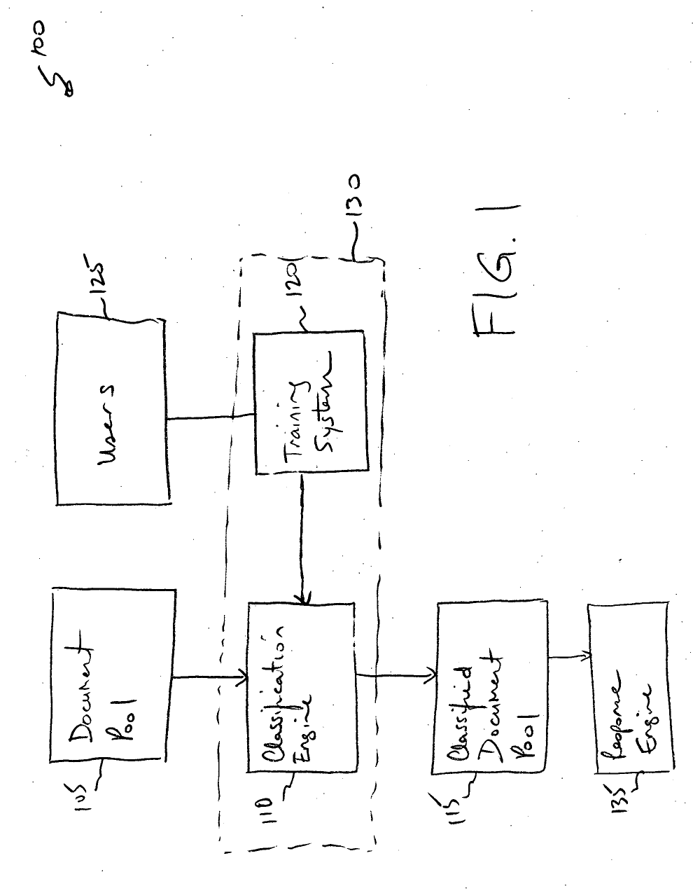

FIG. 1 is a block diagram illustrating a network system 100, in accordance with an embodiment of the present invention. Network system 100 includes a classification engine 110 that uses a classification function to classify documents in a document pool 105 into a classified document pool 115. Network system 100 also includes a response engine 135 that takes the classified documents in the document pool 105 and performs an action thereon in response to the classification. Actions may include moving the document to a particular folder, routing the document to a particular person or persons, deleting the document, etc. Network system 100 also includes a training system 120 (using feature and/or document feedback) that obtains document and feature feedback from users 125 to generate the classification function for the classification engine 100. The classification engine 110 and training system 120 together form the classification system 130.

The document pool 105 may include emails in an email inbox, emails in an entire email system, or emails as they stream through an email server (not shown). The document pool 105 may include the articles of a particular subject, or the result set of a search query.

The training system 120 requests feedback from users 125 on documents and/or feature relevance. For example, if a user 125 wishes to classify certain emails into categories including sports, politics, work, music, religion and events, the training system 120 requests feedback from the user to learn the classification function for classifying the emails into these categories. The training system 120, using active learning techniques, requests the user 125 to classify specific documents, possibly from the document pool 105, into these categories. Then, the training system 120 computes weights for the various features as best as it can with the given documents labeled. To improve classification function generation, the training system 120 requests the user 125 to identify distinguishing features, specifically. For example, the training system 120 may request specific words (or absence of words) that the user 125 knows to be distinguishing of the documents. The user 125 may identify words like “Madonna” or “Springstein” as features suggestive of a document belonging to the “music” category.

Because the training system 120 follows an active learning methodology, the training system 120 may find that documents with the term “Madonna” at times belong to the category of religion and not music. Therefore, the training system 120 may have to determine a second distinguishing feature for categorizing documents containing the word “Madonna” as either belonging to the category of religion or music. However, by learning from the user 125 early on that the term “Madonna” is a distinguishing feature of a document, the training system 120 will likely not need as long to develop its classification function and the resulting classification function may be more accurate and less complex.

Feature classification has applications in email filtering and news filtering, where the user 125 has prior knowledge and a willingness to label some (e.g., as few as possible) documents to build a system that suits his or her needs. Since humans have good intuition of important features in classification tasks (since features are typically words that are perceptible to the human), human prior knowledge can indeed accelerate the development of the document classification function.

The training system 120 according to an embodiment of the present invention incorporates a process that includes training at the feature and at the document level. Another embodiment, may incorporate a process at the feature level and at the user behavior (e.g., query log) monitoring level. At some point, after determining the most relevant features using feature feedback from user(s) 125, the training system 120 can continue active learning according to a more traditional approach, e.g., just selecting documents to obtain feedback on by uncertainty sampling.

When there are few documents in a training set, performance may be better when fewer features are effectively used in the learned categorization function. As the number of documents in the training set increases, the number of features needed for improved accuracy of the categorization function may also increase. For some domains of documents, a large number of features may become important early. Accordingly, the training system 120 may adjust the effective feature set size, for example, by differential weighting and possibly with human feedback, according to the number of training documents available.

With limited labeled data and no feature feedback, the training system 120 would have difficulty determining a distinguishing feature. Feature (dimension) reduction allows the training system 120 to “focus” on dimensions that matter, rather than being “overwhelmed” with numerous dimensions at the outset of learning. Feature reduction lets the training system 120 assign higher weights to fewer features (since those features are often the actual predictive features). Feature feedback also improves example selection, as the training system 120 can develop test examples important for finding better weights on features that matter. As the number of labeled examples increases, feature selection may become less important as the training system 120 will be more capable of finding the discriminating hyperplane (the best feature weights).

For a user who wants to find relevant documents on “cars,” from a human perspective, the word “car” (or “auto,” etc.) may be easily recognized as an important feature in documents discussing this topic. With little labeled data, the training system 120 may be unable to determine the word “car” as a discriminating feature. However, with feature feedback, the training system 120 may be able to generate a document classification function that more accurately finds relevant documents.

In one embodiment, the training system 120 requests users 125 to provide feedback on features, or word n-grams, as well as entire documents. For a given classification problem, the training system 120 may list the top f (e.g., f=5) features as ranked by information gain on the entire labeled set, to avoid wasting the user's time. The training system 120 may randomly mix these top f features with features ranked lower in the list. The training system 120 may present each user with one feature at a time and give them two options—relevant and not-relevant/don't know. A feature may be defined as relevant if it helps to discriminate the positive or the negative class. The feedback may include a sliding scale value, a selected value from a variety of descriptors, etc. The training system 120 need not show the users 125 all features as a list, although such is possible. The training system 120 may ask the users 125 to label documents and features simultaneously, so that the users 125 are influenced by the content of the documents. In another embodiment, the training system 120 may request users 125 to highlight terms as they read documents. The training system 120 may present features to users 125 in context—as lists, with relevant passages, etc., to obtain feature feedback. The training system 120 may apply those terms to generate feature relevance information. If a user 125 labels a feature as relevant, the training system 120 may be configured not to show the user 125 that feature again.

In one embodiment, the training system 120 applies term and document level feedback simultaneously in active learning as follows: Let documents be represented as vectors Xᵢ=xᵢₗ . . . x_{i|F|}, where |F| is the total number of features. At each iteration, the training system 120 queries the user 125 on an uncertain document, presents a list of f features, and asks the user 125 to label the relevant features. The training system 120 may display the top f features to the user 125, ordering the features by information gain. To obtain the information gain values with t labeled instances, the training system 120 may be trained on these t labeled instances. Then, to compute information gain, the five top ranked (farthest from the margin) documents from the unlabeled set in addition to the t labeled documents may be used.

The training system 120 enables the user 125 to label some of the f features considered discriminative. Let s=sₗ . . . s_{|F|} be a vector containing weights of relevant features. If a feature number i that is presented to the user 125 is labeled as relevant, then the classification engine 110 may set sᵢ=a, otherwise sᵢ=b, where a and b are known parameters. The vector s may be imperfect for various reasons: In addition to mistakes made by the user 125 when marking features as relevant, those features that the user 125 might have considered relevant, had he been presented those feature when collecting relevance judgments for features, might not be shown to him. For example, this might correspond to a lazy teacher who labels few features as relevant and leaves some features unlabeled in addition to making mistakes on features marked relevant. In one embodiment, the training system 120 incorporates the vector s as follows. For each Xᵢ in the labeled and unlabeled sets, xᵢⱼ is multiplied by sj to get Xᵢⱼ. In other words, the training system 120 scales relevant features by a and non-relevant features by b. In one example, a=10 and b=1. By scaling important features by a, the training system 120, when using a learning algorithm such as support vector machine, is forced to assign higher weights to these features. If the training system 120 knows the ideal set of features, the value b may be set to 0. However, since user labels are noisy, setting b=1 does not zero-out potentially relevant features. The scaling value may be a binary value, a sliding scale value, e.g., between 1 and 10, a value selected from a set of predetermined values, or a value generated according to a function based on the human feedback.

For each classification problem, the training system 120 maintains a list of features that a user might consider relevant had he been presented that feature. The list may include topic descriptions, names of people, places and organizations that are key players in this topic and other keywords. The words in the list may be assumed equal to the list of relevant features. For example, for an Auto vs. Motorcycles problem, the training system 120 may ask users 125 to label 75% (averaged over multiple iterations and multiple users) of the features at some point or the other. The most informative words—“car” and “bike” may be asked in early iterations. In one embodiment, the term “car” may be presented in the first iteration. The word bike may closely follow, possibly within the first five iterations. In other embodiments, the training system 120 presents the most relevant features within ten iterations. The training system 120 may stop after only ten iterations.

As stated above, as the number of example documents in the training set increases, the effective feature set size (vocabulary) used by the training system 120 may need to increase. A user 125 can help accelerate generating the classification function in this early stage, by pointing out potentially important features or words, adding them to the training set.

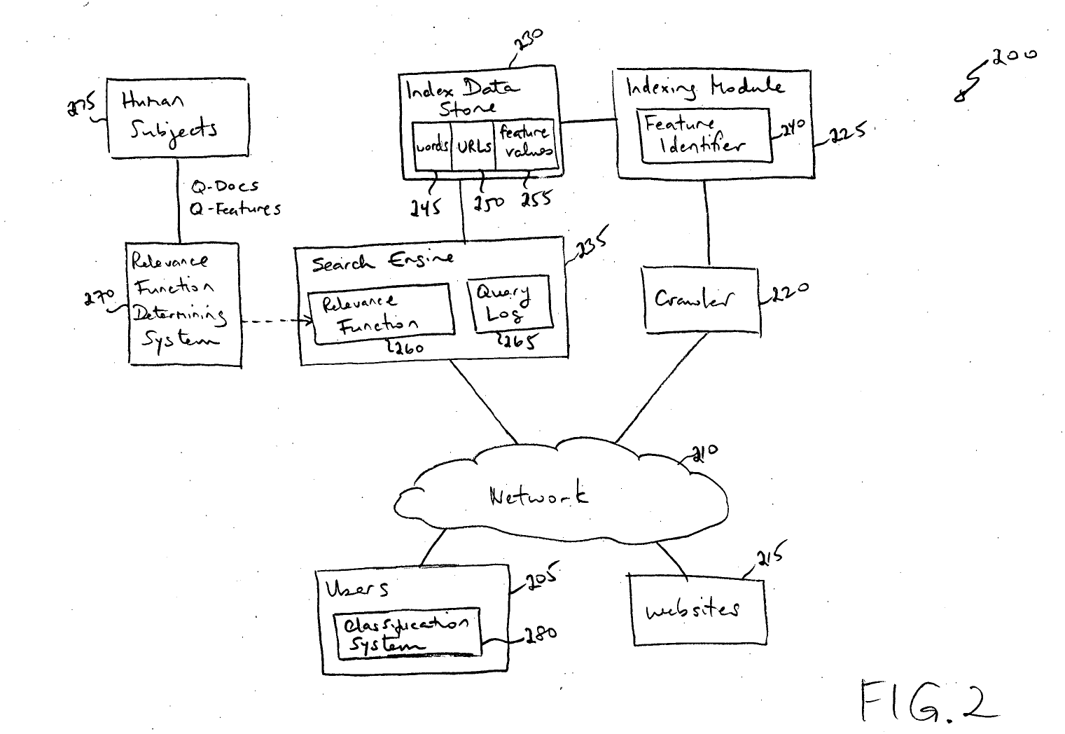

FIG. 2 is a block diagram illustrating an example network system 200 in accordance with a search engine embodiment of the present invention. Network system 200 includes users 205 coupled via a computer network 210 to websites 215. A crawler 220 (sometimes referred to as a robot or spider) is coupled to the network 210. An indexing module 225 is coupled to the crawler 220 and to an index data store 230. A search engine 235 is coupled to the index data store 230 and to the network 235.

The crawler 220 is configured to autonomously and automatically browse the billions of pages of websites 215 on the network 210, e.g., following hyperlinks, conducting searches of various search engines, following URL paths, etc. The crawler 220 obtains the documents (e.g., pages, images, text files, etc.) from the websites 215, and forwards the documents to the indexing module 225. An example crawler 120 is described more completely in U.S. Pat. No. 5,974,455 issued to Louis M. Monier on Oct. 26, 1999, entitled “System and Method for Locating Pages on the World-Wide-Web.”

The indexing module 225 includes a feature identifier 240 configured to parse the documents of the websites 115 received from the crawler 120 for fundamental indexable elements, e.g., atomic pairs of words and locations, dates of publication, domain information, etc. The feature identifier 240 then sorts the information from the many websites 115, according to their features, e.g., website X has 200 instances of the word “dog,” and sends the words, locations, and feature information to the index data store 230. The indexing module 225 may organize the feature information to optimize search query evaluation, e.g., may sort the information according to words, according to locations, etc. An example indexing module 125 is described in U.S. Pat. No. 6,021,409 issued to Burrows, et al., on Feb. 1, 2000, entitled “Method For Parsing, Indexing And Searching World-Wide-Web Pages” (“the Burrows patent”).

The index data store 230 stores the words 245, locations (e.g., URLs 250) and feature values 255 in various formats, e.g., compressed, organized, sorted, grouped, etc. The information is preferably indexed for quick query access. An example index data store 230 is described in detail in the Burrows patent.

The search engine 235 receives queries from users 205, and uses the index data store 230 and a relevance function 260 to determine the most relevant documents in response to the queries. In response to a query, the search engine 235 implements the relevance function 260 to search the index data store 230 for the most relevant websites 215, and returns a list of the most relevant websites 215 to the user 205 issuing the query. The search engine 135 may store the query, the response, and possibly user actions (clicks, time on each site, etc.) in a query log 265, for future analysis, use and/or. relevance function development/modification.

The network system 200 further includes a relevance function determining system 270 coupled to the search engine 235, for generating, providing and/or modifying the relevance function 260. Developing the relevance function 260 is a highly complex task, but is crucial to enabling the search engine 235 to determine relevant information from billions of websites 215 in response to a simple query. An example of relevance function development is described in U.S. application publication No. 2004/0215606 to Cossock, filed on Apr. 25, 2003, entitled “Method And Apparatus For Machine Learning A Document Relevance Function” (“the Cossock application”). Then, based on current events, new features determined, user feedback, e.g., via the query log 265, etc., the relevance function determining system 170 can update/modify the relevance function 160.

In response to a search query, users 205 receive a list of documents that are determined per the relevance function 260 to relate to the user's query. The list may include hundreds of documents, which, from billions of documents, is an excellent feat. However, the documents are typically ordered on the list based on a relevance score determined by the relevance function. The documents are not grouped into convenient categories. For example, a list of documents in response to a search query including the terms “mother” and “board” includes websites relating to computers, environmental health, definitions, marketing and sales, etc.

To assist the user 205 to locate his or her desired response, a classification system 280, which is similar to the classification system 130 of FIG. 1, may be implemented. The classification system 280 may be located on the user's computer, on the search engine 235, or on any computer in the network system 200. The classification system 280 may be trained in accordance with the techniques described above with reference to FIG. 1 and may group the documents of the search results into categories. The categories may include user-defined categories, previously defined categories, dynamically generated categories, and/or various combinations of them. The categories and/or classification functions may be defined prior to the search or may be defined at the time of the search. For example, upon receiving the search results, the user may determine his preference on how to group the results. Alternatively, the user may have previously defined the categories and/or classification functions for this search, or may select from sets of previously defined categories and classification functions relevant to this search. Many other alternatives are possible.

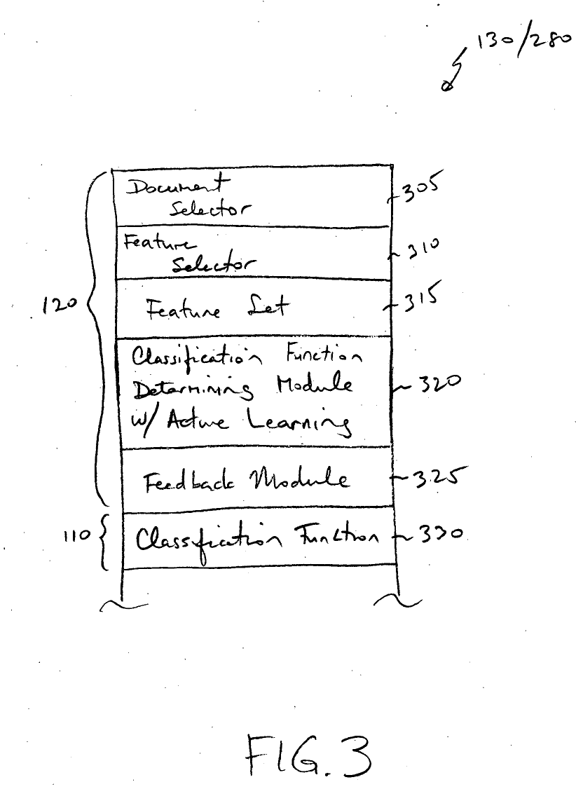

FIG. 3 is a block diagram illustrating details of the classification system 130/280 in accordance with an embodiment of the present invention. The classification system 130/280 includes a document selector 305, a feature selector 310, a feature set 315, a classification function determining module 320, a feedback module 325, and a classification function 330. In one embodiment, the document selector 305, feature selector 310, feature set 315, classification function determining module 320 and feedback module 325 are part of the training system 120 of FIG. 1, and the classification function 330 is part of the classification engine 110 of FIG. 1.

The document selector 305 includes the algorithms for labeling documents, possibly by presentation to user 125. In one example, the document selector 305 obtains a respective set of result documents. The document selector 305 selects a document from the set, and requests the user 125 to assign the document to a corresponding category (or categories). Then, the document selector 305 uses the documents, the categories and the user's feedback to the classification function determining module 320.

The feature selector 310 includes algorithms for labeling features, possibly by presentation to user 125. In one example, the feature selector 310 gathers the features from the feature set 315, presents them to the users 125 relative to a category or set of categories, and requests the users 125 to assign relevance scores (which may be a binary value, a sliding scale value, a value selected from a predetermined set of values or descriptors, etc.) to the features with respect to the category or categories. The features classifier 310 may also present contextual information, such as lists, document paragraphs, summary information, etc. The feature selector 310 provides the features, the categories, and the relevance scores to the classification function determining module 320.

The feature set 315 includes features that may be relevant to a given category or to a given set of documents. For example, the feature set 315 may include words to find in the documents, words not to find in the documents, the number of times a word appears in a document, peoples' names, events, dates, etc. The feature set 315 may be generated automatically from sets of documents or may be provided by the users 125. The feature sets 315 may change over time, e.g., due to changing current events, lexicography, etc.

The classification function determining module (with active learning) 320 obtains the feature set, documents, categories, and the user's feature and document relevance feedback. The classification function determining module 320 may use all or part of the information to generate the classification function 330. The classification function determining module 320 may identify weights for features deemed relevant and weights for features deemed not relevant. Thus, as the classification function determining module 320 learns more about how humans weigh the relevance of features, the classification function determining module 320 may change its weighting values on those features. Further, the classification function determining module 320 may be capable of having different weighting values for different categories, different users 125, etc.

The feedback module 325 may monitor the users 125 actions to determine whether the user 125 is reclassifying documents to improve the classification function. In another embodiment, the feedback module 325 may improve the cold-start problem, such that the feedback module 325 may gather user classifications that can be used as training information to developing the classification function.

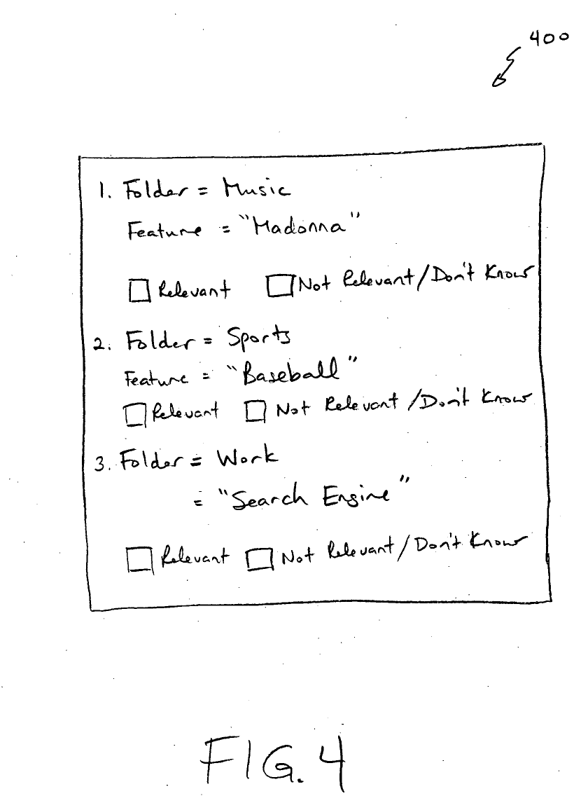

FIG. 4 illustrates example feature feedback requests 400 of users 125. As shown, question number one requests user feedback on the relevance of the term “Madonna” in a document for a folder category of “music.” Based on opinion, the user 125 can select relevant or not relevant/don't know. Questions two and three request the opinion of user on the relevance of the features of “baseball” and “search engine” to the folders of “sports” and “work,” respectively. Of course, other questions (e.g., category-to-feature relevance opinion requests) are also possible.

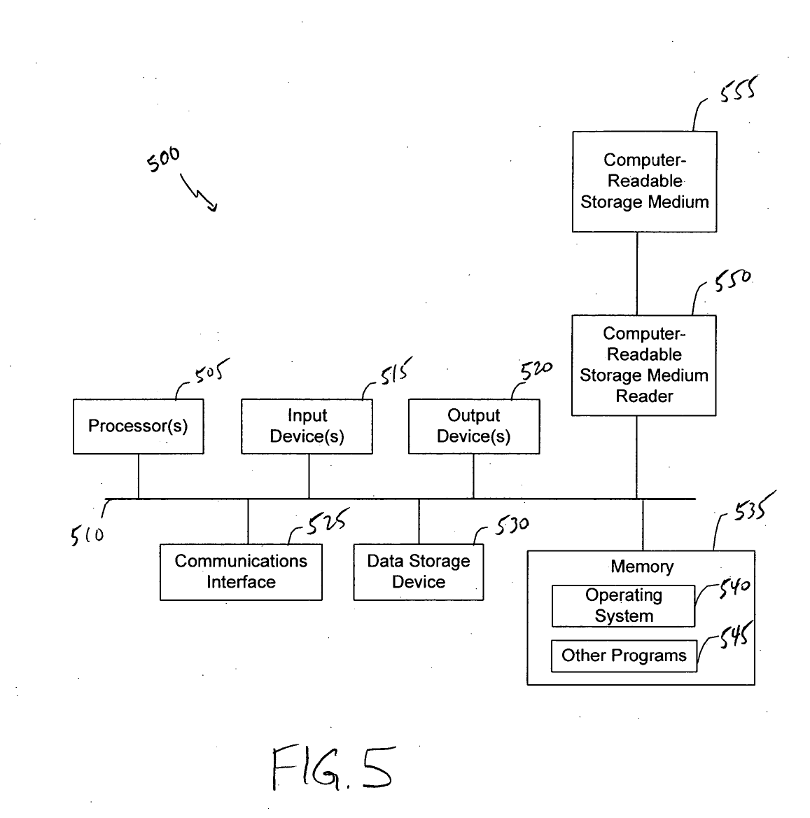

FIG. 5 is a block diagram illustrating details of an example computer system 500, of which the classification engine 110, the training system 120, the relevance function determining system 170, the search engine 135, the crawler 120, the users 105, the websites 115, the indexing module 125, and the index data store 130 may be instances. Computer system 500 includes a processor 505, such as an Intel Pentium® microprocessor or a Motorola Power PC® microprocessor, coupled to a communications channel 510. The computer system 500 further includes an input device 515 such as a keyboard or mouse, an output device 520 such as a cathode ray tube display, a communications device 525, a data storage device 530 such as a magnetic disk, and memory 535 such as Random-Access Memory (RAM), each coupled to the communications channel 510. The communications interface 525 may be coupled to a network such as the wide-area network commonly referred to as the Internet. One skilled in the art will recognize that, although the data storage device 530 and memory 535 are illustrated as different units, the data storage device 530 and memory 535 can be parts of the same unit, distributed units, virtual memory, etc.

The data storage device 530 and/or memory 535 may store an operating system 540 such as the Microsoft Windows NT or Windows/95 Operating System (OS), the IBM OS/2 operating system, the MAC OS, or UNIX operating system and/or other programs 545. It will be appreciated that an embodiment may be implemented on platforms and operating systems other than those mentioned. An embodiment may be written using JAVA, C, and/or C++ language, or other programming languages, possibly using object oriented programming methodology.

One skilled in the art will recognize that the computer system 500 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 550 such as a magnetic disk drive, hard disk drive, magneto-optical reader, CPU, etc. may be coupled to the communications bus 510 for reading a computer-readable storage medium (CRSM) 555 such as a magnetic disk, a hard disk, a magneto-optical disk, RAM, etc. Accordingly, the computer system 500 may receive programs and/or data via the CRSM reader 550. Further, it will be appreciated that the term “memory” herein is intended to cover all data storage media whether permanent or temporary.

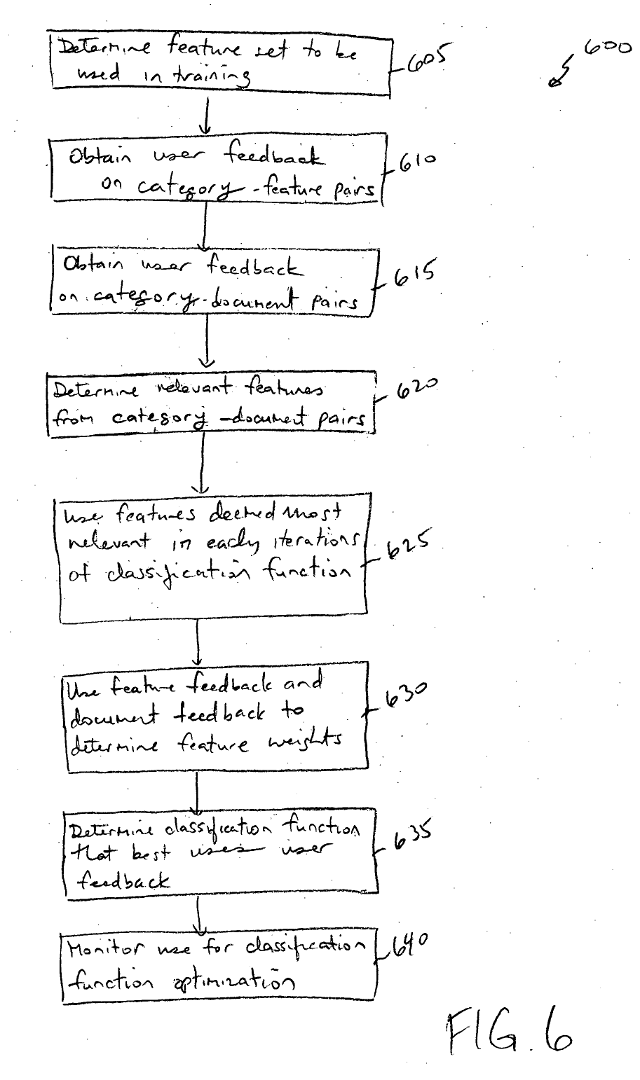

FIG. 6 is a flowchart illustrating a method 600 of developing a classification function, in accordance with an embodiment of the present invention. Method 600 begins in step 605 with determining a feature set, e.g., feature set 315, to be used in training. The feature set may be developed automatically, manually, and/or possibly by users 125. The feature selector 310 of the training system 120 in step 610 then obtains human subject feedback on category-feature pairs, such as those shown in FIG. 4. The document selector 315 of the training system in step 615 then selects documents and obtains user feedback on document-category pairs. This step may be implemented simultaneously with step 610 or at a different time.

The classification function determining module 320 in step 620 determines which features are deemed most relevant by the users 125. The classification function determining module 320 in step 625 uses the features deemed most relevant in early iterations of classification function development. Using the features deemed most relevant and document-category feedback, the classification function determining module 320 in step 630 determines feature weighting for the classification function 330 and in step 635 determines the classification function 330 that best uses user 125 feedback. Method 600 then ends.

Although the embodiments herein are being described with reference to document classification, the invention may be applied to other scenarios including object recognition in an image, where features may be other perceptible objects, concepts or portions of images.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method for facilitating development of a document classification function, the method comprising:
selecting a feature of a document, the feature being less than an entirety of the document;
presenting the feature to a human subject;
asking the human subject for a feature relevance value of the feature; and
generating a classification function using the feature relevance value.

2. The method of claim 1, wherein the feature includes one of a word choice, a synonym, a date, an event, a person or link information.

3. The method of claim 1, wherein the feature relevance value is a binary variable.

4. The method of claim 1, wherein the feature relevance value is a sliding scale value.

5. The method of claim 1, wherein the feature relevance value is selected from a set of values.

6. The method as recited in claim 1, further comprising:
presenting the document to the human subject at the same time as presenting the feature;
asking the human subject for document relevance value that measures relevance of the document to a category; and
wherein the generating the classification function also uses the document relevance value.

7. The method of claim 6, wherein the document relevance value is a binary value.

8. The method of claim 6, wherein the document relevance value is a sliding scale value.

9. The method of claim 6, wherein the document relevance value is a value selected from a set of values.

10. The method of claim 1, wherein the generating of the classification function includes assuming that the features deemed most relevant according to the feature relevance values are the most relevant features for evaluating relevance of a document to a category.

11. The method of claim 1, wherein the generating the classification function includes generating a feature weight based on the feature relevance value.

12. The method of claim 11, further comprising monitoring user actions, and modifying the feature weight based on the monitoring.

13. A system for facilitating development of a classification function, the system comprising:
a feature selector for presenting a feature of a document to a human subject, the feature being less than an entirety of the document, and for asking the human subject for a feature relevance value of the feature; and
a classification function determining module for generating a classification function using the feature relevance value.

14. The system of claim 13, wherein the feature includes one of a word choice, a synonym, a date, an event, a person or link information.

15. The system of claim 13, wherein the feature relevance value is a binary variable.

16. The system of claim 13, wherein the feature relevance value is a sliding scale value.

17. The system of claim 13, wherein the feature relevance value is selected from a set of values.

18. The system as recited in claim 13, further comprising:
a document selector for presenting a document to the human subject at the same time as presenting the feature, and for asking the human subject for a document relevance value that measures relevance of the document to a category; and
wherein the classification function determining module also uses the document relevance value to generate the classification function.

19. The system of claim 18, wherein the document relevance value is a binary value.

20. The system of claim 18, wherein the document relevance value is a sliding scale value.

21. The system of claim 18, wherein the document relevance value is a value selected from a set of values.

22. The system of claim 13, wherein classification function determining module assumes that the features deemed most relevant according to the feature relevance value are the most relevant features for evaluating relevance of a document to a category.

23. The system of claim 13, wherein the classification function determining module generates a feature weight based on the feature relevance value.

24. The system of claim 13, further comprising a feedback module for monitoring user actions, and modifying the feature weight based on the monitoring.

25. A system for facilitating development of a classification function, the system comprising:
means for presenting a feature of a document to a human subject, the feature being less than an entirety of the document;
means for asking the human subject for a feature relevance value of the feature; and
means for generating a classification function using the feature relevance value.

26. A method for facilitating development of a document classification function, the method comprising:
enabling a human subject to identify a distinguishing feature of a document, the feature being less than an entirety of the document; and
generating a classification function using the distinguishing feature.

27. A method for facilitating development of a document classification function, the method comprising:
selecting a plurality of features of a document, each of the features being less than an entirety of the document;
presenting the features to a human subject;
asking the human subject for feature relevance values of the features; and
generating a classification function using the feature relevance values.

28. The method of claim 27, wherein the presenting includes presenting the features one at a time.

29. The method of claim 27, wherein the presenting includes presenting the features as a list.

30. The method of claim 27, wherein the presenting includes presenting the features with document content information.
